(19) United States
(12) Patent Application Publication
(10) Pub. No.: US 2013/0079690 A1
(43) Pub. Date: Mar. 28, 2013

(54) MUSCLE STRETCHING DEVICE

(71) Applicant: Jui Yao CHEN, Changhua County (TW)

(72) Inventor: Jui Yao CHEN, Changhua County (TW)

(21) Appl. No.: 13/241,224

(22) Filed: Sep. 23, 2011

(51) Int. Cl. A61H 7/00

(52) U.S. Cl. 601/134

(57) ABSTRACT

A muscle stretching device essentially comprises a base and an outer cover pivoted to each other. In the base are provided a motion transmission device, a lifting mechanism, an inner cover. The lifting mechanism comprises gear shafts, pushing members disposed in the gears shafts, and screws screwed in the threaded holes of the pushing members. By such arrangements, the motion transmission device drives the gear shafts and the screws of the lifting mechanism to rotate synchronously, and the pushing members are restricted in the restricting holes of the inner cover and therefore move along the screws to control rise and fall of the outer cover.

### BACKGROUND OF THE INVENTION

1. Field of the Invention

The present invention relates to a muscle stretching device.

2. Description of the Prior Art

Staying in a position for a long time or anxiety may cause muscle tension, which will result in aches or even cause discomfort in other parts of the body if the muscle is not relaxed appropriately. Conventional methods for muscle relaxation normally involve manual massage or the use of massage device.

The principle of muscle relaxation is to tension the muscle then relax it slowly like a spring. Manual massage or massage device uses hands or massage members to massage the local muscle groups in a kneading manner, which just can relax the muscle for a while but not for good.

Furthermore, manual massage is laborsome and cost ineffective. As for the massage device, when the massage device is small, such as a massage stick, the user has to keep holding it with hands throughout the duration of the massage, which not only causes muscle tension in the hands, shoulder and neck of the user, but also the massage effect is limited. If the massage device is big, such as a massage chair, it is big and expensive, and therefore, is not affordable to everyone.

The present invention has arisen to mitigate and/or obviate the afore-described disadvantages.

### SUMMARY OF THE INVENTION

The primary object of the present invention is to provide a muscle stretching device, wherein a lifting mechanism can change user's body position by changing the inclination of the rest surface of the muscle stretching device supporting the user, and thus the muscles in the neck, back, waist and spine and joints can be effectively stretched and relaxed.

Another object of the present invention is to provide a muscle stretching device which is capable restoring muscle elasticity and improving body shape.

To achieve the above objects, a muscle stretching device essentially comprises a base and an outer cover pivoted to each other. In the base are provided a motion transmission device, a lifting mechanism, an inner cover. The motion transmission device includes two gears and a motor. The two gears are two-stage gears and each provided with a large-diameter toothed wheel and a small-diameter toothed wheel, respectively. The motor includes a drive shaft to be disposed between the gears and synchronously engaged with the large-diameter toothed wheels. The lifting mechanism comprises two gear shafts, two shaft sleeves, two pushing members and two screws, on a middle of each of the two gear shafts is provided a toothed wheel to be engaged with the small-diameter toothed wheels of the gears respectively. At both ends of the respective gear shafts are formed a restricting groove and a circular groove, respectively, in such a manner that the restricting groove is located toward the base, each of the pushing members being polygonal in cross section and received in the receiving grooves of the gear shafts. Each of the screws is formed with a restricting head and inserted in the gear shafts and screwed in the threaded holes of the pushing members, and the restricting heads are engaged in the restricting grooves.

By such arrangements, the motion transmission device drives the gear shafts and the screws of the lifting mechanism to rotate synchronously, and the pushing members are restricted in the restricting holes of the inner cover and therefore move along the screws to control rise and fall of the outer cover.

### BRIEF DESCRIPTION OF THE DRAWINGS

FIG. 1 is an exploded view of a muscle stretching device in accordance with the present invention;

FIG. 2 is an assembly view of the muscle stretching device in accordance with the present invention;

FIG. 3 is a top cross sectional view of the muscle stretching device in accordance with the present invention;

FIG. 4 is a cross sectional view taken along the line 4-4 of FIG. 3;

FIG. 5 is a cross sectional view taken along the line 5-5 of FIG. 3;

FIG. 6 is a cross sectional view taken along the line 6-6 of FIG. 3;

FIG. 7 is a cross sectional view taken along the line 7-7 of FIG. 3;

FIG. 8 shows another embodiment of the muscle stretching device in accordance with the present invention;

FIG. 9a shows that the muscle stretching device in accordance with the present invention is applied to the neck;

FIG. 9b shows that the muscle stretching device in accordance with the present invention is applied to the feet; and

FIG. 9c shows that the muscle stretching device in accordance with the present invention is applied to the waist.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

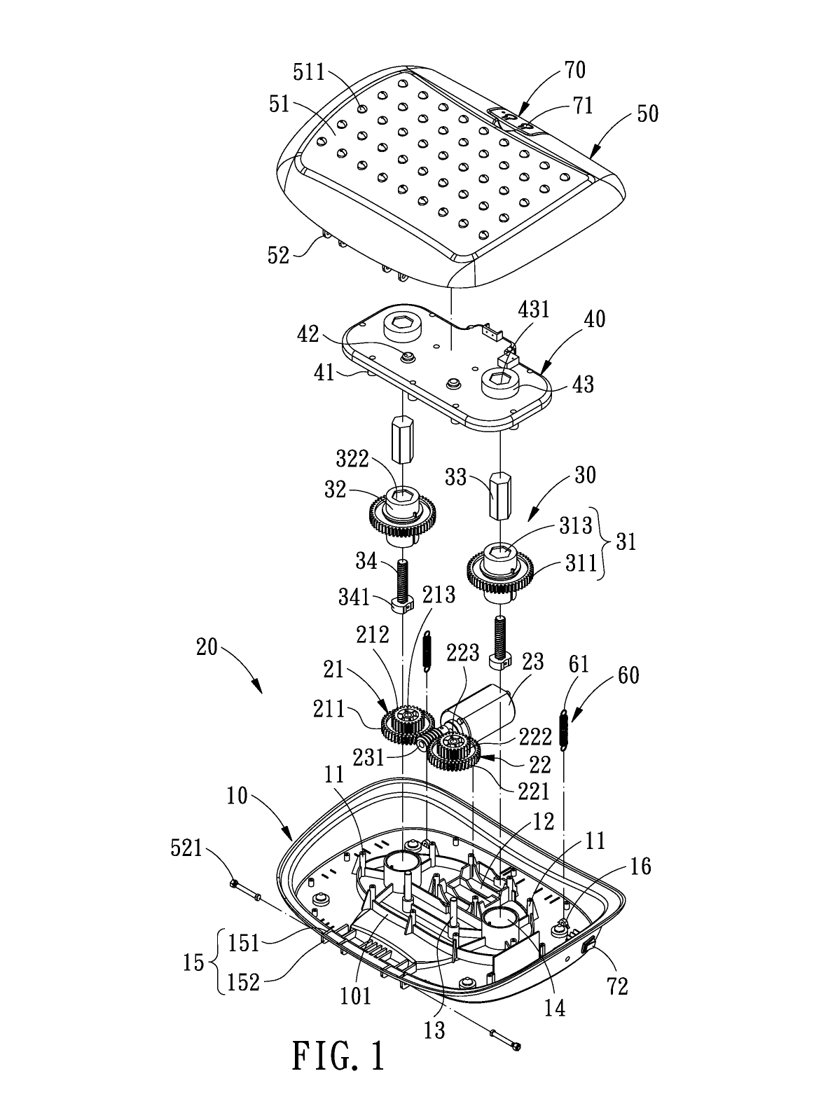

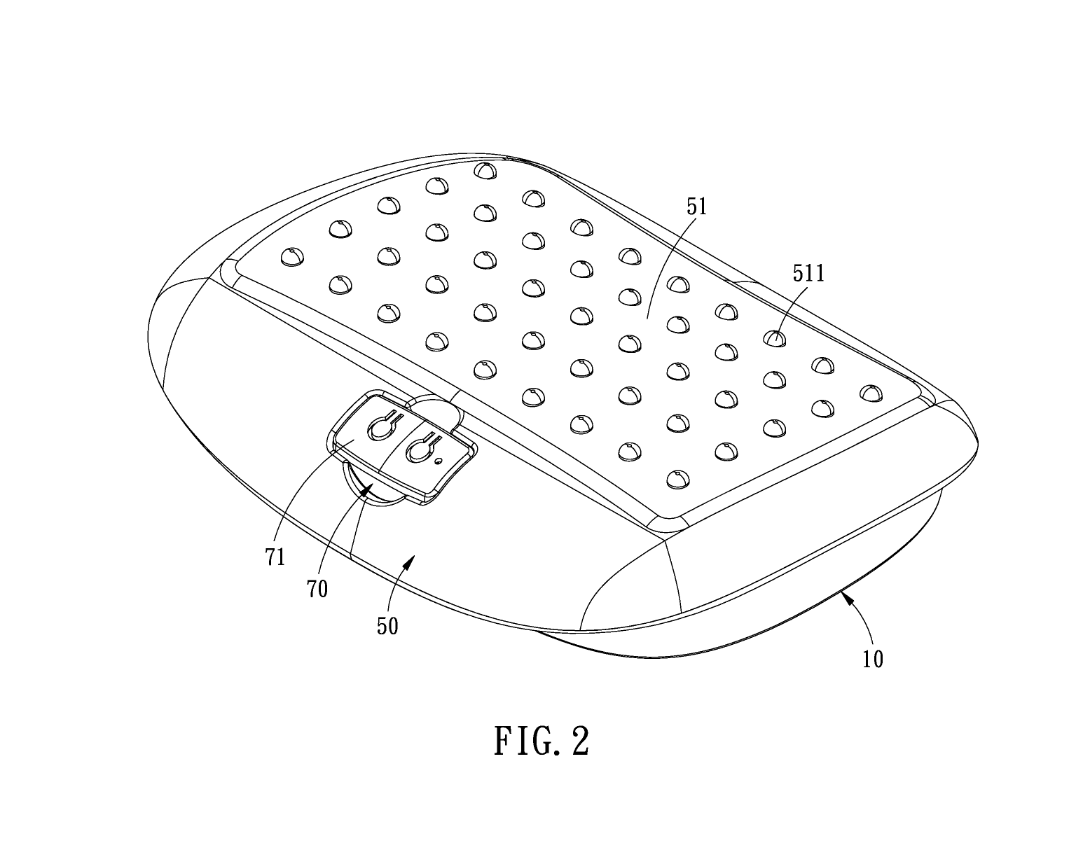

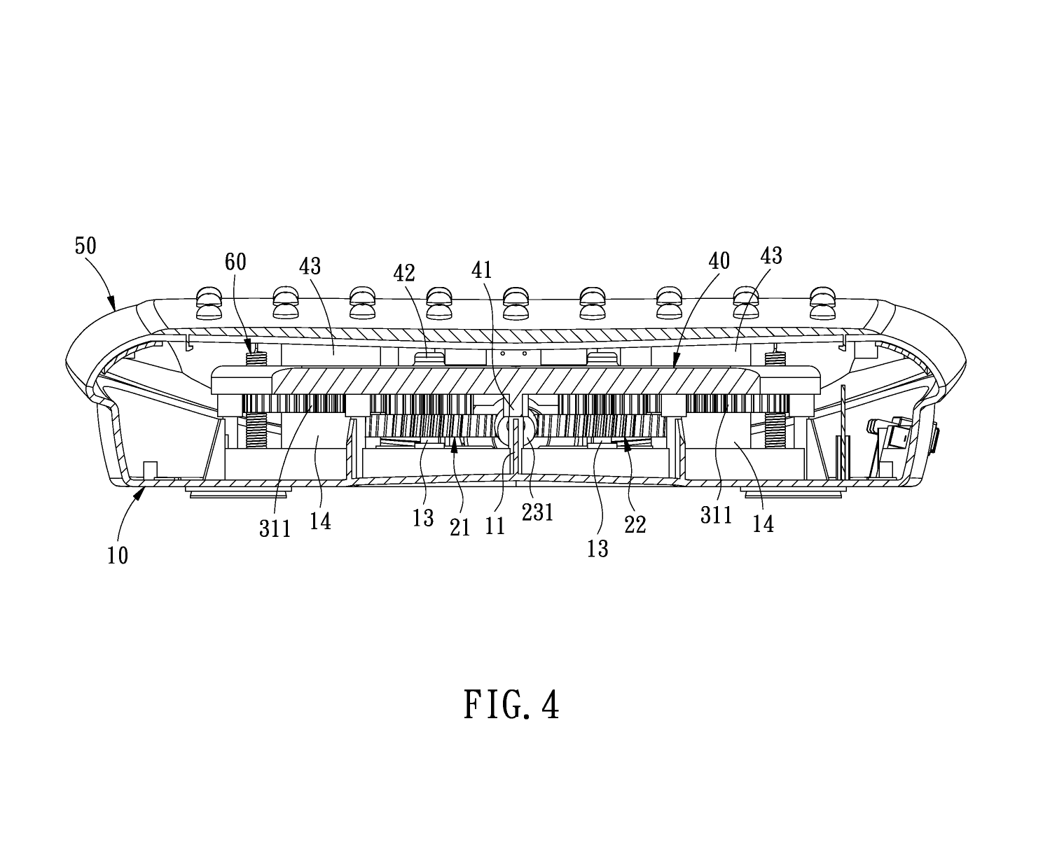

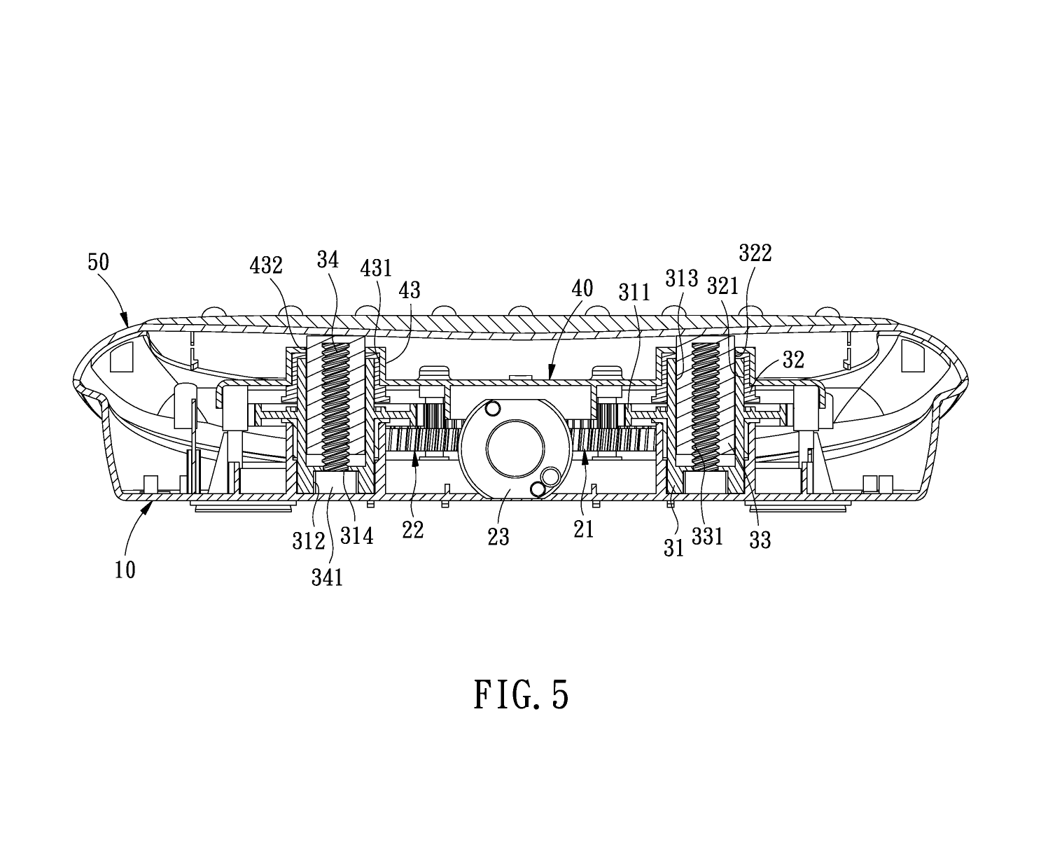

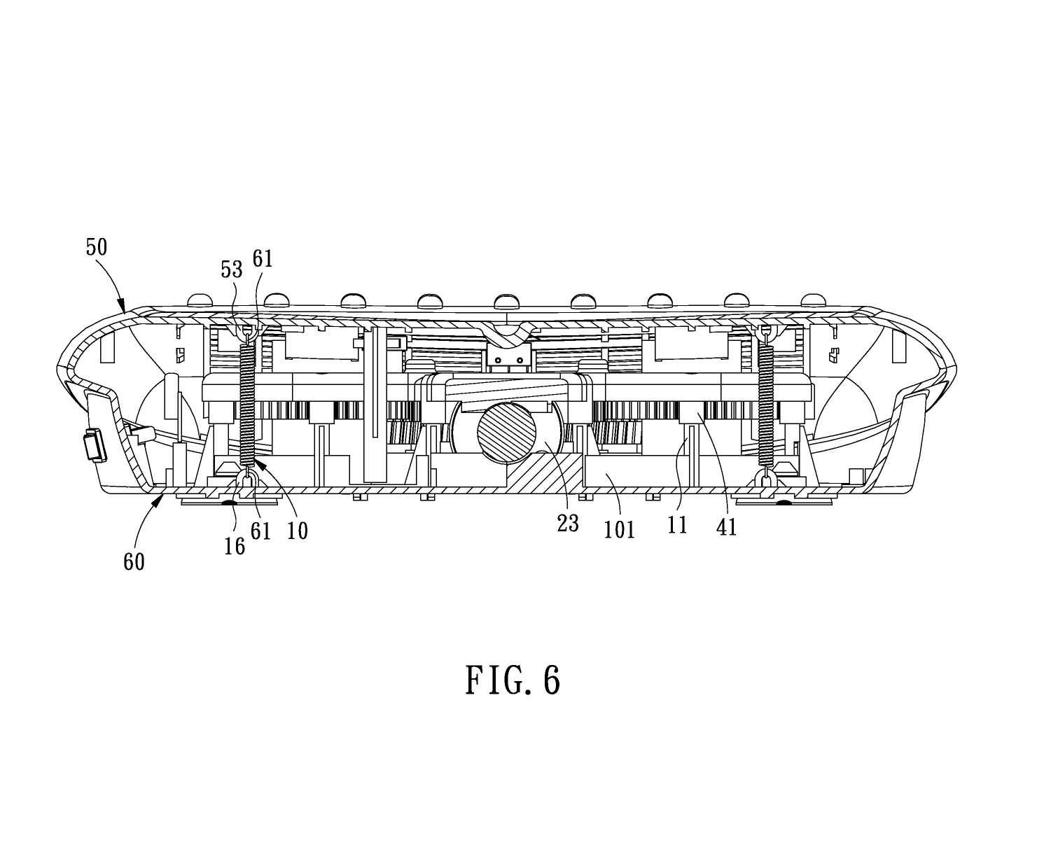

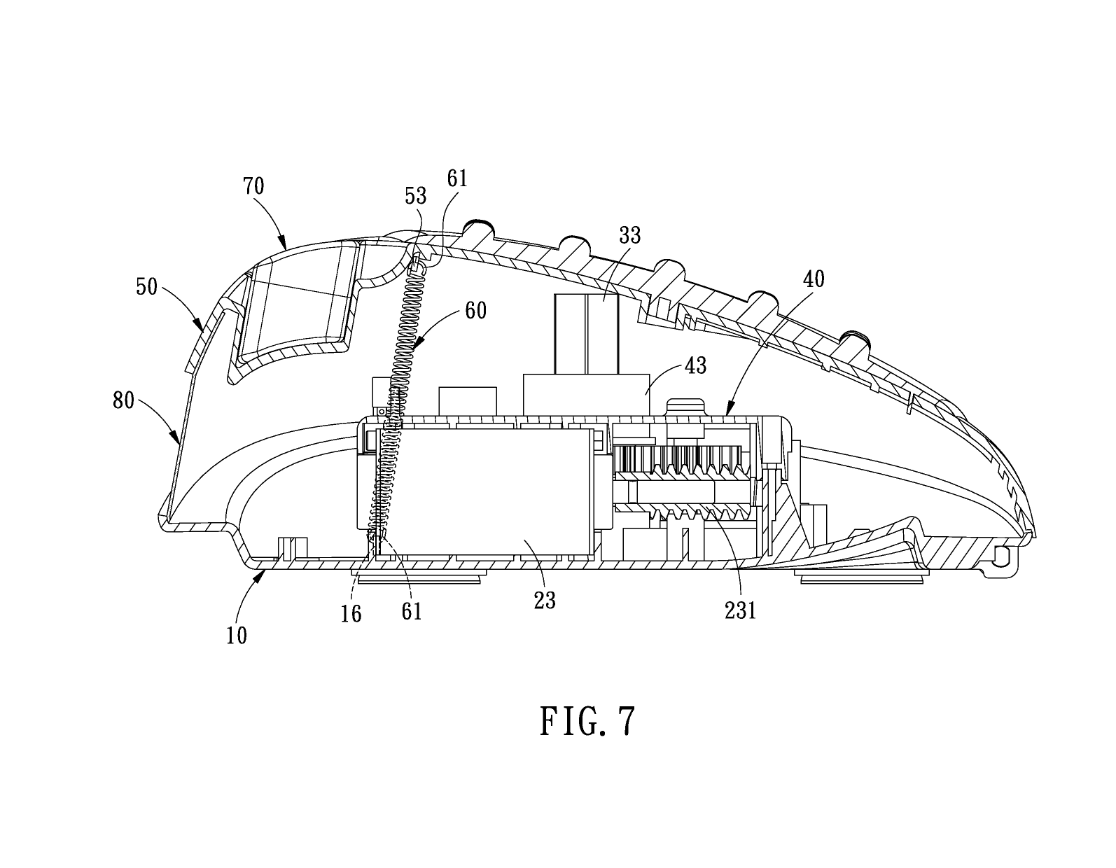

Referring to FIGS. 1-7, a preferred embodiment of a muscle stretching device in accordance with the present invention comprises a base 10, a motion transmission device 20, a lifting mechanism 30, an inner cover 40, an outer cover 50 and at least one elastic member 60.

The base 10 is a concave structure formed with at least one hook hole 16 and a mounting portion 101 which is formed with a plurality of mounting protrusions 11 around the periphery therefore. The mounting portion 101 is further formed with a groove 12, two inserting rods 13 and two receiving concaves 14.

The motion transmission device 20 is mounted in the mounting portion 101 of the base 10 and includes two gears 21, 22 and a motor 23. The two gears 21, 22 are two-stage gears and each are provided with a large-diameter toothed wheel 211, 221 and a small-diameter toothed wheel 212, 222, respectively. The two gears 21, 22 are further each provided with an axial hole 213, 223. The motor 23 includes a drive shaft 231 to be disposed between the gears 21 and 22 and synchronously engaged with the large-diameter toothed wheels 211 and 221. The motor 23 is received in the groove 12, and the two inserting rods 13 are inserted in the axial holes 213, 223 of the gears 21, 22, respectively.

The lifting mechanism 30 is mounted in the mounting portion 101 of the base 10 and comprises two gear shafts 31, two shaft sleeves 32, two pushing members 33 and two screws 34. On the middle of each of the two gear shafts 31 is provided a toothed wheel 311 to be engaged with the small-diameter toothed wheels 212, 222 of the gears 21, 22, respectively. At both ends of the respective gear shafts 31 are formed a restricting groove 312 and a circular receiving groove 313, respectively, in such a manner that the restricting groove 312 is located toward the base 10, and a through hole 314 is formed between the restricting groove 312 and the circular receiving groove 313 to make the restricting groove 312 and the circular receiving groove 313 communicate with each other. Each of the pushing members 33 is polygonal in cross section, formed at one end thereof with a threaded hole 331 and received in the receiving grooves 313 of the gear shafts 31.

The shaft sleeves 32 are formed with an inner space 321, respectively, for insertion of the ends of the gear shafts 31 where the receiving grooves 313 are formed. In the bottom of the inner space 321 is formed a polygonal hole 322 shaped to fit the cross section of the pushing members 33. Each of the screws 34 is formed with a restricting head 341 and is inserted through the restricting groove 312, the through hole 314 and finally into the receiving groove 313 of the gear shafts 31 in such a manner that the screws 34 are screwed in the threaded holes 331 of the pushing members 33, and the restricting heads 341 are engaged in the restricting grooves 312. in this embodiment, the restricting grooves of the gear shafts 31 and the restricting heads 341 of the screws 34 are non-circular structure so as to effect synchronous motion of the gear shafts 31 and the screws 34.

The inner cover 40 is provided around its periphery with a plurality of mounting concaves 41 for insertion of the mounting protrusions 11 of the mounting portion 101 of the base 10, and is further formed with two inserting grooves 42 for insertion of the two inserting rods 13 of the base 10, and two sunken portions 43 for cooperating with the two receiving grooves 14 of the base 10. Each of the sunken portions 43 is formed with a restricting hole 431 in the shape of the cross section of the pushing members 33. The base 10 and the inner cover 40 are engaged with each other in such a manner that the motor 23 is received between the groove 12 of the base 10 and the inner cover 40, the two inserting rods 13 are inserted through the gears 21, 22 and finally into the two inserting grooves 42 of the inner cover 40, and the gear shafts 31 of the lifting mechanism 30 are received between the receiving concaves 14 of the base 10 and the sunken portions 43 of the inner cover 40.

The outer cover 50 is a concave structure to be pivoted to the base 10 and formed with at least one hook hole 53 located corresponding to the hook hole 16 of the base 10. In this embodiment, the outer cover 50 is formed with a rest surface 51 for user's neck, back, waist, feet or other parts to lean against, and on the rest surface 51 is provided a plurality of massage balls 511 for massage purpose.

The base 10 is provided with a pivoting portion 15 on its periphery adjacent to the two gears 21, 22. The pivoting portion 15 is formed with four pivoting grooves 151, each of which is defined by two opposite pivoting pieces 152, the outer cover 50 is formed with four pivoting ears 52 to be inserted in the pivoting grooves 151, and then two pivots 521 are inserted in the pivoting ears 52, so that the outer cover 50 is pivoted to the base 10.

The elastic member 60 has two hooks 61 formed at both ends thereof, one of the hooks 61 is hooked in the hook hole 16 of the base 10, and the other one of the hooks 61 is hooked in the hook hole 53 of the outer cover 50. In this embodiment, there are two elastic members 60 symmetrically disposed between the base 10 and the outer cover 50, providing a prestressing force to ensure that the outer cover 50 can be closed against the base 10 when the pushing members 33 of the lifting mechanism 30 are retracted.

By such arrangements, the motion transmission device 20 drives the gear shafts 31 and the screws 34 of the lifting mechanism 30 to rotate synchronously in such a manner that the pushing members 33 are restricted in the restricting holes 431 of the inner cover 40 and therefore move along the screws 34 to control the rise and fall of the outer cover 50.

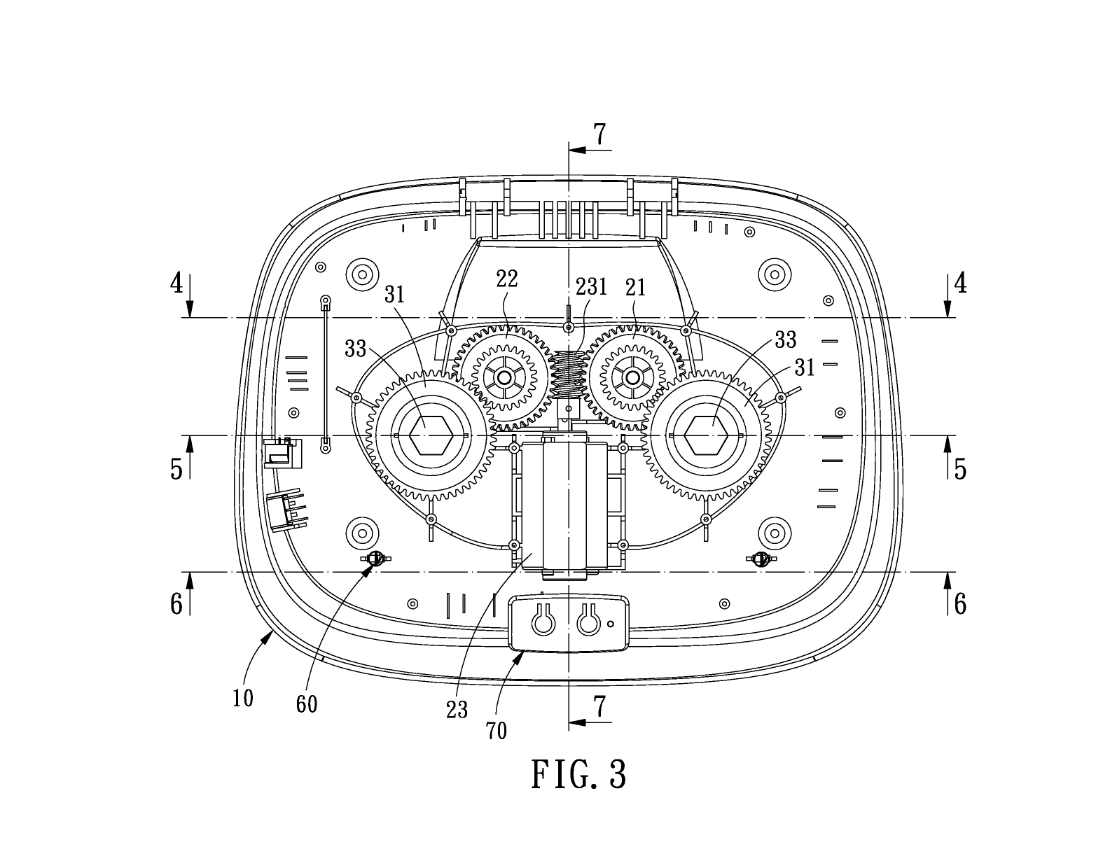

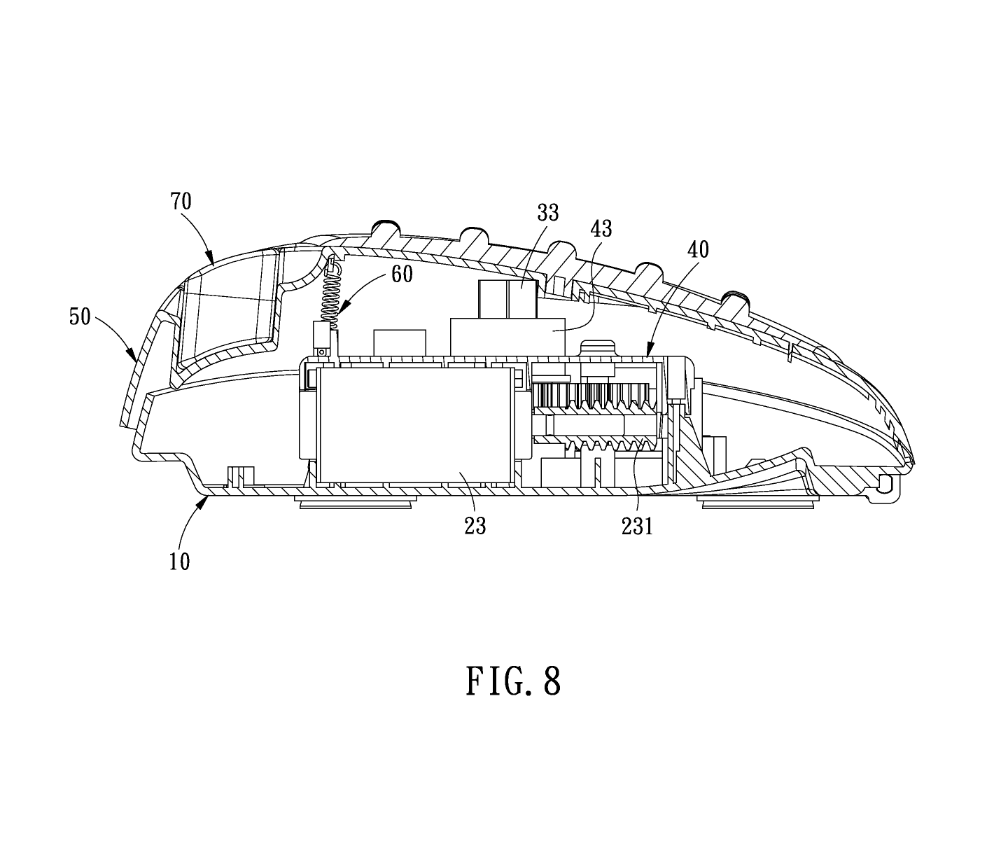

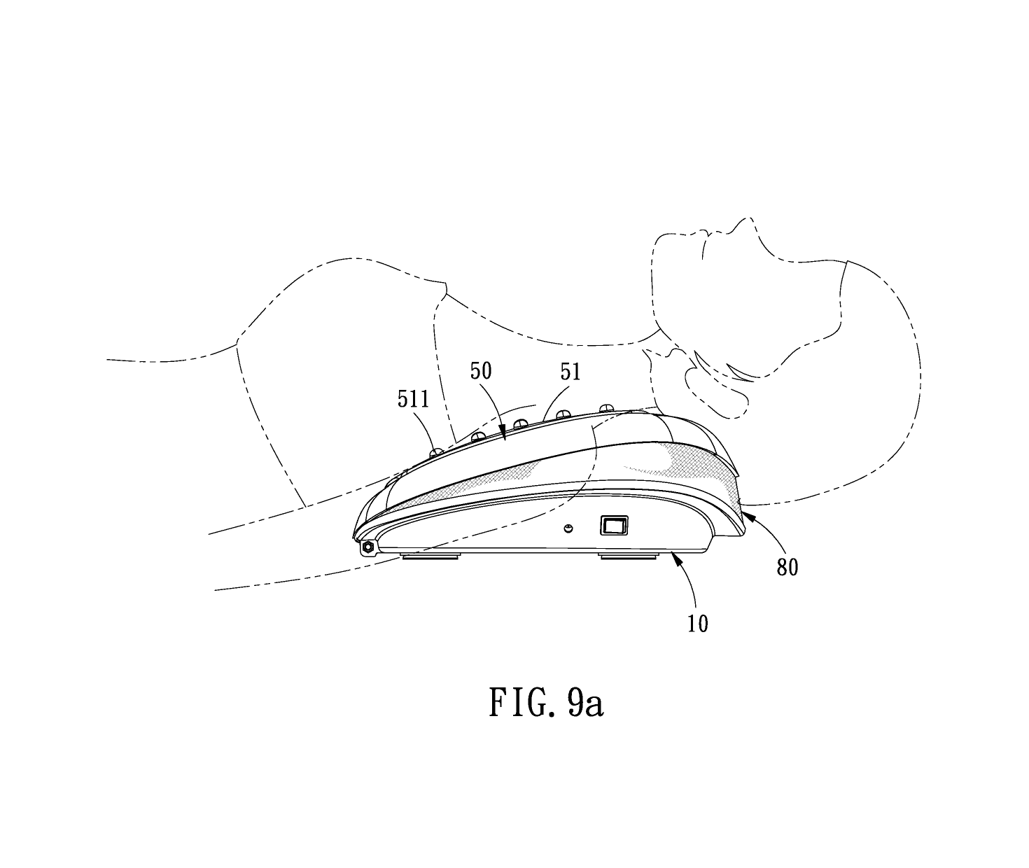

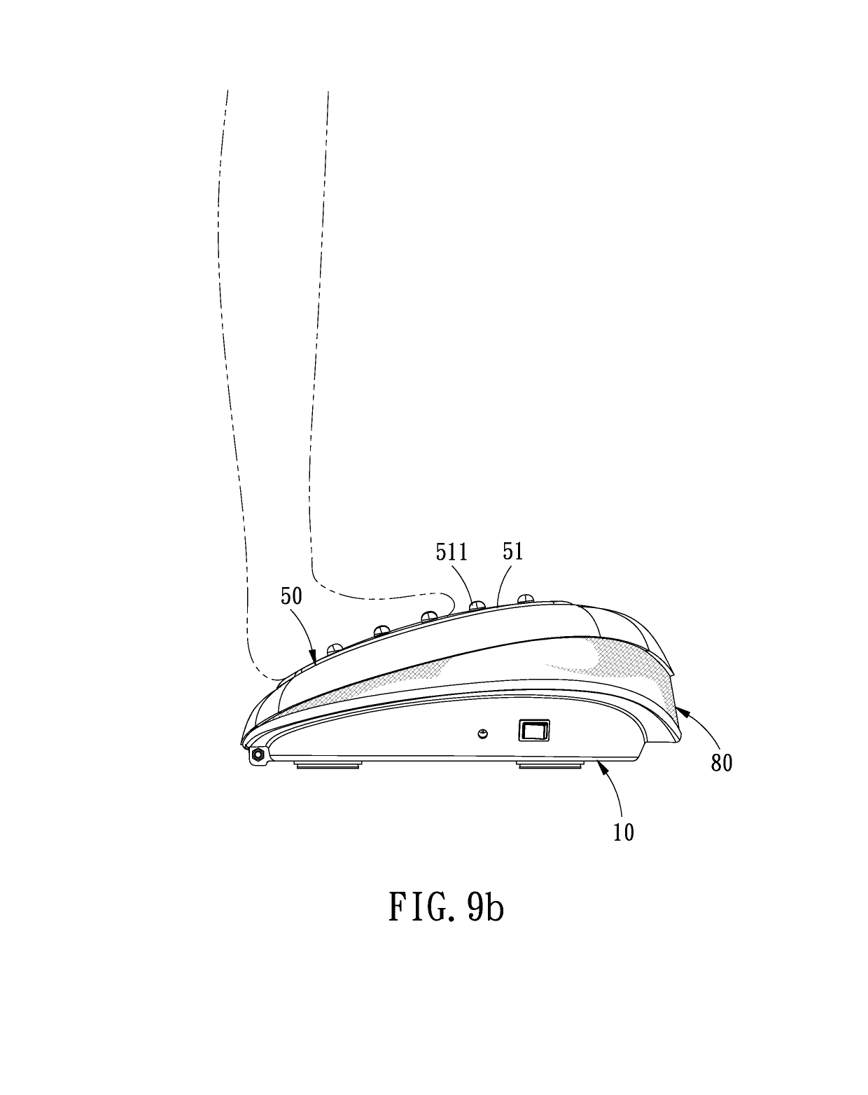

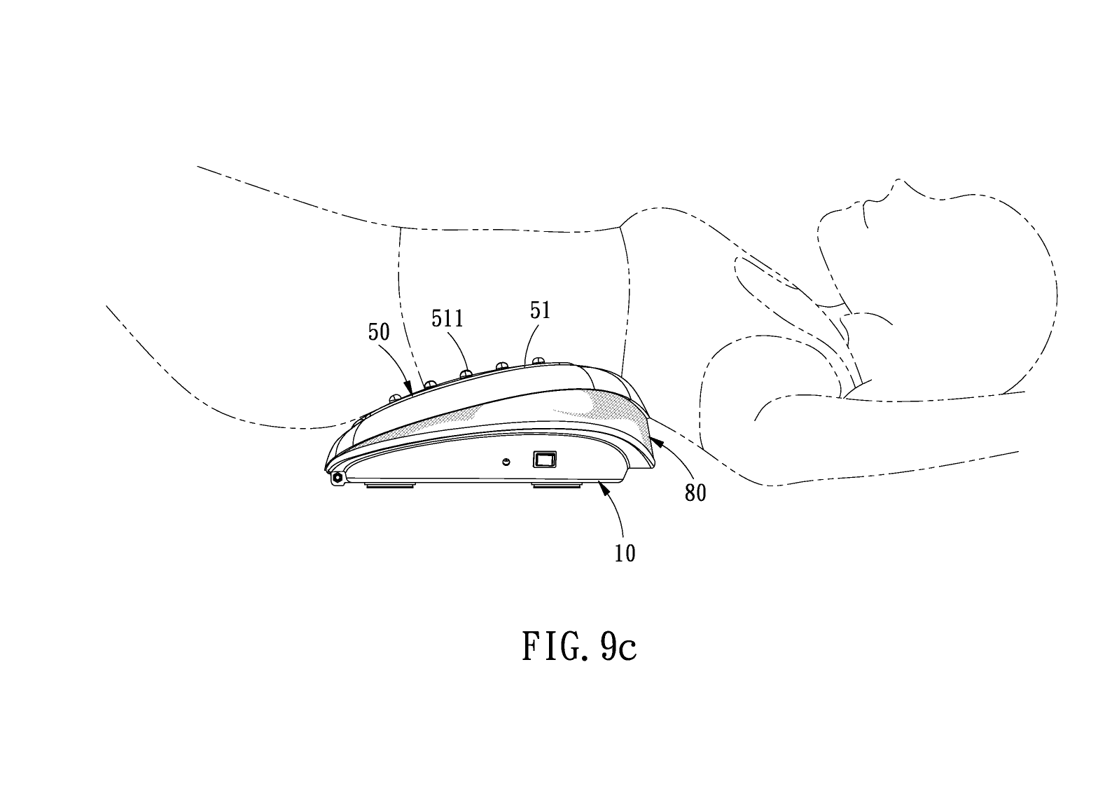

Referring then to FIGS. 1 and 3, the outer cover 50 is provided with a control unit 70 which includes a control panel 71 disposed on the outer surface of the outer cover 50 and a switch 72 on the outer surface of the base 10. As shown in FIGS. 9a-9c, a cloth layer 80 is connected between the periphery of the base 10 and that of the outer cover 50. As shown in FIG. 8, the periphery of the outer cover 50 is thicker and larger than that of the base 10, so as to cover the base 10 and the switch of the outer cover 50 when the outer cover 50 is lifted.

Referring then to FIGS. 3, 5 and 7, which illustrate the lifting and operation of the muscle stretching device in accordance with the present invention, wherein the motor 23 of the transmission device rotates the gears 21, 22, and consequently rotating the gear shafts 31 and the screws 34 of the lifting mechanism 30. since the pushing members 33 of the gear shafts 31 are polygonal and restricted in the restricting holes 431 of the inner cover 40, when the screws 34 rotate, the pushing members 33 will move upward along the screws 34 to push up the outer cover 50, so as to change the inclination of the outer cover 50, and consequently changing the body position of the user who is pushed by the outer cover 50. As shown in FIGS. 9a-9c, which show that the muscle stretching device is applied to the back, legs and waist of the user. With the inclination of the outer cover 50 and the radian of the rest surface 51, the muscles, and the spine and joints of the user can be effectively and smoothly stretched and relaxed, so as to restore muscle elasticity and improve body shape.

While we have shown and described various embodiments in accordance with the present invention, it is clear to those skilled in the art that further embodiments may be made without departing from the scope of the present invention.

What is claimed is:

1. A muscle stretching device comprising:
a base formed with at least one hook hole and a mounting portion which is formed with a plurality of mounting protrusions around its periphery therefore, the mounting portion being further formed with a groove, two inserting rods and two receiving concaves;
a motion transmission device mounted in the mounting portion of the base and including two gears and a motor, the two gears being two-stage gears and each provided with a large-diameter toothed wheel and a small-diameter toothed wheel, respectively, the motor including a drive shaft to be disposed between the gears and synchronously engaged with the large-diameter toothed wheels, the motor being received in the groove, and the two inserting rods being inserted in the two gears, respectively;
a lifting mechanism mounted in the mounting portion of the base and comprising two gear shafts, two shaft sleeves, two pushing members and two screws, on a middle of each of the two gear shafts being provided a toothed wheel to be engaged with the small-diameter toothed wheels of the gears, respectively, at both ends of the respective gear shafts being formed a restricting groove and a circular receiving groove, respectively, in such a manner that the restricting groove is located toward the base, each of the pushing members being polygonal in cross section, formed at one end thereof with a threaded hole and received in the circular receiving grooves of the gear shafts, the shaft sleeves being formed with an inner space, respectively, for insertion of ends of the gear shafts where the circular receiving grooves are formed, in a bottom of the inner space being formed a polygonal hole shaped to fit the cross section of the pushing members, each of the screws being formed with a restricting head and inserted in the gear shafts and screwed in the threaded holes of the pushing members, and the restricting heads being engaged in the restricting grooves;
an inner cover provided around its periphery with a plurality of mounting concaves for insertion of the mounting protrusions of the mounting portion of the base, and further formed with two inserting grooves for insertion of the two inserting rods of the base, and two sunken portions for cooperating with the two receiving grooves of the base, each of the sunken portions being formed with a restricting hole in the shape of the cross section of the pushing members, the base and the inner cover being engaged with each other in such a manner that the motor is received between the groove of the base and the inner cover, the two inserting rods are inserted through the gears and finally into the two inserting grooves of the inner cover, and the gear shafts of the lifting mechanism are received between the receiving concaves of the base and the sunken portions of the inner cover;
an outer cover pivoted to the base and formed with at least one hook hole located corresponding to the hook hole of the base; and
at least one elastic member having two hooks formed at both ends thereof, one of the hooks being hooked in the hook hole of the base, and another one of the hooks being hooked in the hook hole of the outer cover;
by such arrangements, the motion transmission device drives the gear shafts and the screws of the lifting mechanism to rotate synchronously, and the pushing members are restricted in the restricting holes of the inner cover and therefore move along the screws to control rise and fall of the outer cover.

2. The muscle stretching device as claimed in claim 1, wherein the base and the outer cover are each formed with two hook holes, and there are two elastic members symmetrically disposed between the base and the outer cover.

3. The muscle stretching device as claimed in claim 1, wherein the outer cover is formed with a rest surface, and on the rest surface is provided a plurality of massage balls.

4. The muscle stretching device as claimed in claim 1, wherein the base is provided with a pivoting portion on its periphery adjacent to the two gears, the pivoting portion is formed with four pivoting grooves, the outer cover is formed with four pivoting ears to be inserted in the pivoting grooves, and then two pivots are inserted in the pivoting ears, so that the outer cover is pivoted to the base.

5. The muscle stretching device as claimed in claim 1, wherein the outer cover is provided with a control unit which includes a control panel disposed on an outer surface of the outer cover and a switch on an outer surface of the base.

6. The muscle stretching device as claimed in claim 1, wherein a cloth layer is connected between a periphery of the base and that of the outer cover.
